(19) United States
(12) Patent Application Publication
(10) Pub. No.: US 2004/0036428 A1
(43) Pub. Date: Feb. 26, 2004

(54) Direction detection and count method for three channel commutation sensor

(75) Inventors: Nhan Xuan Bui, Tucson, AZ (US); John Alexander Koski, Livermore, CA (US); Eiji Ogura, Yokohama-shi (JP); Kazuhiro Tsuruta, Sagamihara City (JP)

Correspondence Address: Scully, Scott, Murphy & Presser, 400 Garden City Plaza, Garden City, NY, 11530, US

(73) Assignee: International Business Machines Corporation, Armonk, NY

(21) Appl. No.: 10/223,967

(22) Filed: Aug. 20, 2002

(51) Int. Cl. H02P 7/06

(52) U.S. Cl. 318/254

(57) ABSTRACT

A method and system for detecting and counting angular rotation of a rotating rotor of a brushless DC motor. The position of the rotor is sensed with a group of sensors. The group of sensors have at least six states determined by the position of the rotor, and in each of these states, the group of sensors define an associated, respective numeric value. At defined periods, the state of the sensors is identified, and the numeric value associated with that state is used to determine the direction of rotation of the rotor and the angular movement of the rotor during the time of the period. In a preferred embodiment, the group of sensors includes at least three sensors, and each of the associated numeric values includes at least three digits. Also, in each of the at least six states, each of the at least three sensors contributes one digit to the numeric value associated with the state.

### BACKGROUND OF THE INVENTION

1. Field of the Invention

This invention generally relates to brushless DC motors, and more specifically, the invention relates to methods and systems for detecting the direction and amount of rotation of such a motor.

2. Background Art

DC brushless motors are widely used due to their simplicity of design, durability and efficiency. For example, DC brushless motors are commonly used in computer storage devices, such as spindle motors of hard disc, CD-ROM, CD-RW, DVD, and tape drive devices.

When used in a tape drive, the motors are subjected to large velocity variations, including operating in both forward and reverse directions and at zero velocity. At the same time, it is critical to keep a precise count of the tape travel, which can be both forward and backwards, and which also can be quite long, both in distance and time.

A common configuration for controlling the excitation of a brushless motor in these types of applications is to provide a set of power switches that apply voltage to the motor windings, and a multi-channel commutation sensor. The on and off states of the switches are controlled by a commutator circuit that receives, as inputs, the outputs of the multi-channel sensor. The multi channel sensor provides logic control signals to select the proper set of power switches for motor excitation. The windings of the motor that must be excited are a function of the angular position of the motor armature. This multi-channel sensor is often implemented with Hall devices that directly respond to the magnetic field in the vicinity of the armature, as the armature rotates near the Hall devices.

The number of stator windings of the brushless motor often determines the number of channels for the commutation sensor. A two phase brushless motor is easily commutated with a two channel commutation sensor. For a three phase brushless DC motor, a three channel commutation sensor may be used. This three phase configuration is very common in brushless motor designs, since it provides advantages in generating smooth torque, with simplicity of design and low cost. The three channels of the sensor define six excitation states for the motor windings, each state being uniquely defined by the combined binary states of the three sensor signals. This method of commutation control of brushless DC motors is well understood by those skilled in the art.

As indicated above, when brushless DC motors are used with tape drive devices, there is often the need for monitoring the total angular displacement of the motor over long tape distances and long periods of time. There are many ways to accomplish this, and for instance, an incremental encoder tachometer is often used to provide logic pulses that can be used to sense direction of rotation and be counted by hardware or software up-down counters to maintain position information. Such an encoder typically is a two-channel device with a quadrature phase shift between the channels that allows direction of rotation to be sensed. This procedure, as well as the other established techniques for monitoring the angular displacement of brushless DC motors, have not proven to be completely satisfactory, however, since it requires, in addition to the motor, an encoder with added costs and space requirements.

### SUMMARY OF THE INVENTION

An object of this invention is to improve procedures for monitoring the angular displacement of brushless DC motors.

Another object of the present invention is to detect the rotational direction and to provide count information to a counter for a three channel commutation sensor of a brushless DC motor.

These and other objectives are attained with a method and system for detecting and counting angular rotation of a rotating rotor of a brushless DC motor. The position of the rotor is sensed with a group of sensors. This group of sensors has at least six states, which are determined by the position of the rotor; and in each of these states, the group of sensors define an associated, respective numeric value. At defined periods, the state of the sensors is identified, and the numeric value associated with that state is used to determine the direction of rotation of the rotor and the angular movement of the rotor during the time of the period. In a preferred embodiment, the group of sensors includes at least three sensors, and each of the associated numeric values includes at least three binary digits. Also, in each of the at least six states, each of the at least three sensors contributes one binary digit to the numeric value associated with the state.

The preferred embodiment of the invention, described below in detail, is ideally suited for a counter implemented in hardware, or alternatively in software. The technique makes use of an adder (signed numbers providing subtraction) instead of standard logic blocks of counters. The use of an adder provides the capability to handle the condition of very high speeds that may cause more than a single change of the sensor states between count intervals. The use of an adder also provides the capability to handle the condition of a low power mode for logic hardware which requires very long time intervals when the logic hardware does not respond to changes in the sensor state. The method may be effectively implemented to detect direction of rotation and up to three increments in count position simultaneously.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 is a schematic diagram of a brushless motor system with which the present invention may be used.

FIG. 2 shows the three channel signal states of the commutation sensor of the motor system of FIG. 1.

FIG. 3 is a table showing the signal states in a binary format, and also giving the binary formats of adjacent states.

FIG. 4 is a flow chart illustrating a procedure for monitoring the angular displacement of the motor system using the binary logic states of the table of FIG. 3.

FIG. 5 shows a tape drive mechanism incorporating the motor system of FIG. 1.

### DETAILED DESCRIPTION OF THE PREFERRED EMBODIMENTS

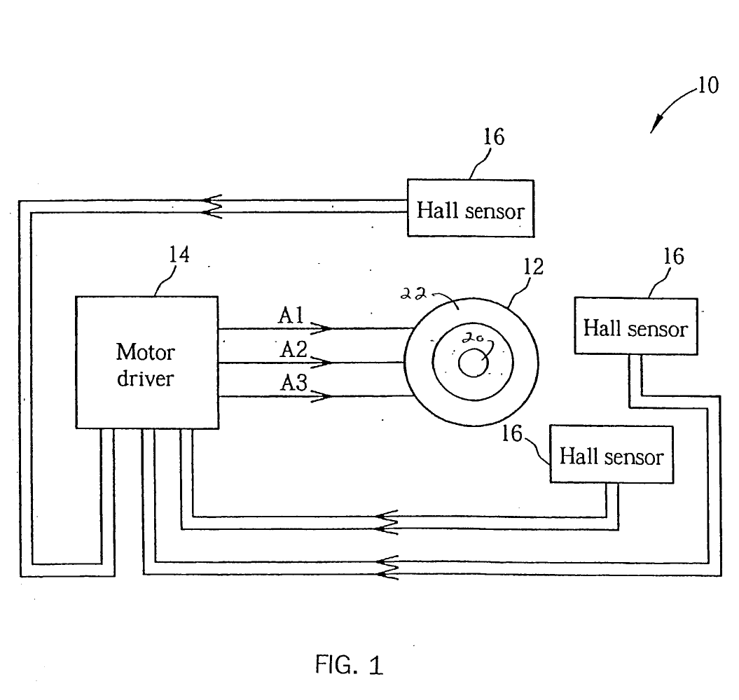

FIG. 1 shows a brushless motor system 10, comprising a three-phase brushless motor 12, a driver 14, and three Hall sensors 16. The motor 12 includes a rotor 20 and a stator 22. The Hall sensors 16 are used to detect the rotor position, and the driver 14 drives the rotor of the motor 12 based upon the rotor position as detected by the Hall sensors. In particular, as the rotor rotates, each of the Hall sensors generates and sends two corresponding sensing signals to the driver 14. The driver 14, using suitable motor excitation switches, outputs three phase currents A1, A2 and A3 to drive the brushless motor 12 based upon the sensing signals generated and output by the three Hall sensors 16.

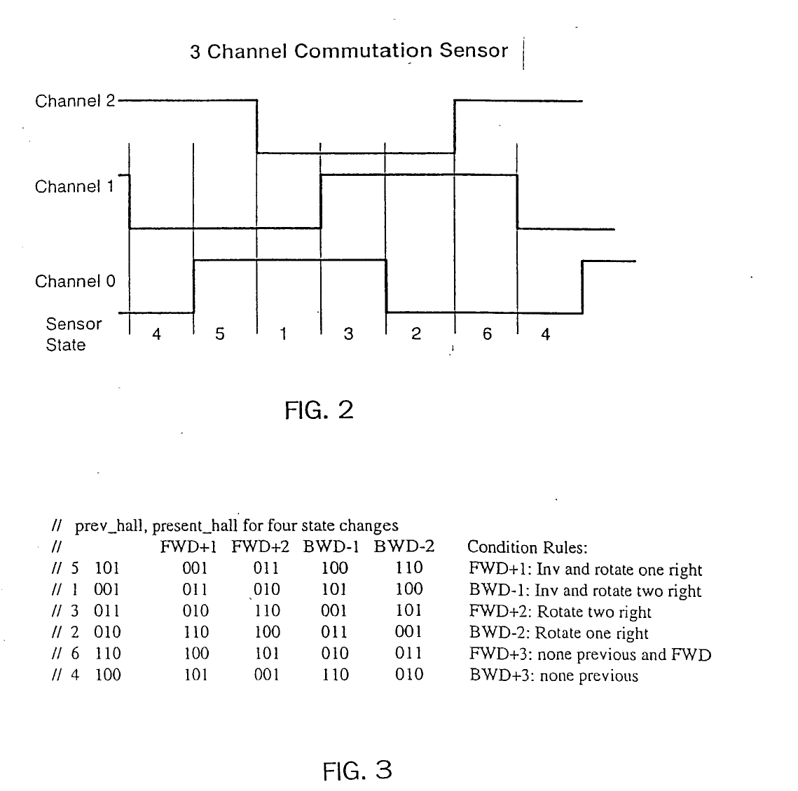

The present invention, generally, relates to a method and system to detect the rotational direction of the brushless motor 12 and to provide count information to a counter for a three channel commutation sensor of the motor. The three channel sensor provides signal states as shown in FIG. 2 and as represented in FIG. 3. This relationship for the sensor channels allows it to be used to select directly the on and off states of the motor excitation switches using combinatorial logic, such as “and” and “or” gates. The on and off states of the excitation switches are a logical combination of these three signals.

The normal sequence of the states of the commutation sensor shown in FIG. 2 for forward rotation, given that forward rotation is from left to right in the Figure, is defined as 4, 5, 1, 3, 2, 6, 4, . . . The backward sequence of states for this sensor is defined as 4, 6, 2, 3, 1, 5, 4, . . . For any given state, there is one adjacent state for forward, and one adjacent state for backward. For instance, state 3 has state 2 as the forward adjacent state, and state 1 as the backward adjacent state. Thus, for example, a transition from state 3 to state 2 indicates forward rotation with a change of count of plus one, and a transition from state 3 to state 1 indicates backward rotation with a change of count of minus one.

For any given state, there is only one second-adjacent state for forward rotation, and only one second-adjacent state for backward rotation. For example, state 3 has state 6 as a forward second-adjacent state, and state 5 as a backward second-adjacent state. A transition from state 3 to state 6 indicates forward rotation with a change of count of plus two. A transition from state 3 to state 5 indicates backward rotation with a change of count of minus two.

For changes of commutation sensor states greater than two, the velocity required for this result is so great that a change of direction could not have occurred since the previous direction detection based on one or two state changes. The acceleration rate of the brushless motor is not great enough to cause a change from two sensor states in one direction to two sensor states in the opposite direction, within the time interval at which the logic samples the sensor.

Therefore, the current direction of rotation must be the direction sense provided by the previous sensor transition with one or two adjacent state changes. Thus, when the adjacent state changes by more than two, the previously detected direction is applied to the current state change, and the count value equal to the displacement of sensor states is added (or subtracted) to the previous count value. This method of preserving direction and spanning multiple state changes extends the counter change value to plus and minus three.

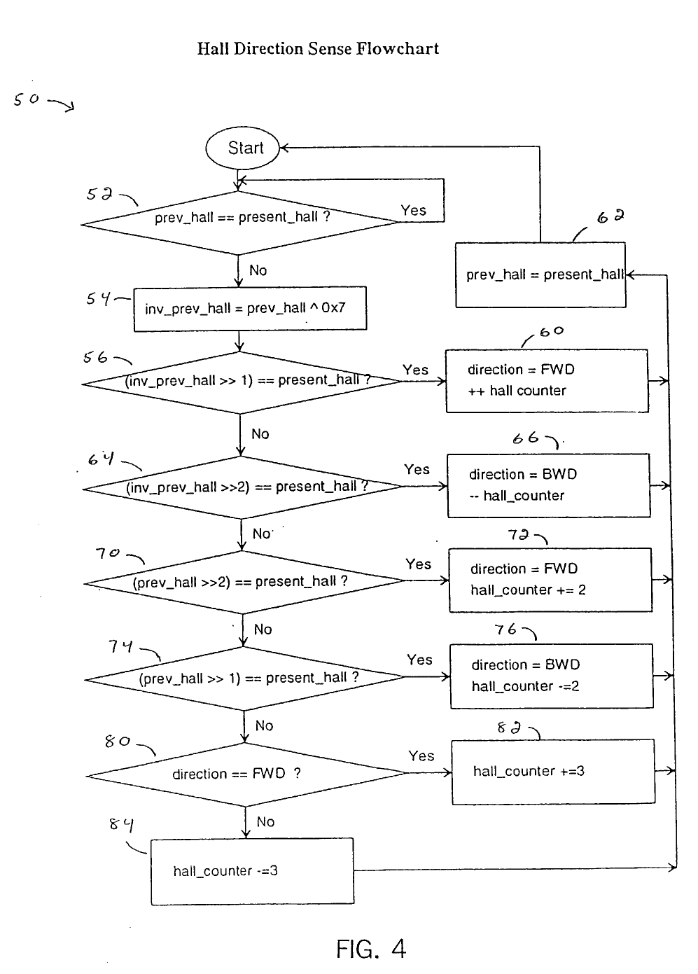

FIG. 4 is a flow chart showing a preferred procedure, generally referenced as 50, for determining rotor direction sense and the number for the interval of adjacent state changes. This routine is started and run at defined times, and preferably the routine is initiated at regular intervals. The routine 50 uses a number of variables, designated as “present_hall,” “prev_hall,” “direction,” and “hall-counter.” “present_hall” is the value of the Hall sensors at the current position of the rotor, and “prev_hall” is the value of the Hall sensors the previous time the routine was run. “direction” is a variable indicating the motor direction, and this value can be either FWD (for forward) or BWD (for backwards). “hall-counter” is the value of a counter that keeps track of the angular rotation of the rotor.

At step 52, the present hall sensor value is compared to the previous hall value. If these two values are the same, the rotor has not moved since the routine was last run, and if this is the case, the hall counter is not increased. Step 52 is repeated until the two compared values, present_hall and prev_hall, are not the same, and when this is the case, the routine moves on to step 54.

At step 54, a value, inverted previous hall, is determined. To obtain this value, the exclusive or operation is performed on two values, the previous hall value and the value of 7 in hexidecimal units—0111. The inverted previous hall value is set equal to the result of this exclusive or operation, and the routine proceeds to step 56.

At this step, the inverted previous hall value is shifted one bit to the right, with the rightmost bit wrapped around to the left end, and the resultant value is compared to the present hall value. If these two values are equal, the routine goes to step 60. The motor direction is forward and the hall counter is incremented by 1. From step 60, the routine moves on to step 62, where the variable, previous hall value, is set equal to the present hall value.

If at step 56, the two compared values are not equal, the routine proceeds to step 64, where the inverted previous hall value is shifted two bits to the right, with the two rightmost bits wrapped around the left end, and the resultant value is compared to the present hall value. If these two values are equal, the routine goes to step 66. The motor direction is backwards, the hall counter is decremented by one, and the routine then proceeds to step 62. If at step 64, the two compared values are not equal, the routine 50 moves to step 70.

At this step 70, the previous hall value is shifted two bits to the right, with the two rightmost bits wrapping around the left end of the value, and the resultant value is compared to the present hall value. If these values are equal, the motor is operating in the forward direction; and at step 72, the hall counter is incremented by two, and the routine proceeds to step 62. If, however, the two values compared at step 70 are not equal, the routine goes to step 74.

At step 74, the previous hall value is shifted one bit to the right, with the rightmost bit wrapping around the left end of the value, and the resultant value is compared to the present hall value. If these two values are equal, the motor direction is backwards; and at step 76, the hall counter is decremented by two, and the routine moves on to step 62. If, at step 74, the compared values are not equal, the routine goes to step 80.

If the routine reaches step 80, the rotor has rotated through three increments, either forwards or backwards, and the direction of the rotor is consider to be, the same as the rotor direction the last time routine was run. More specifically, at step 80, the routine tests to determine if the motor direction is forward. If it is, the routine proceeds to step 82, and the hall counter is incremented by three and the routine then moves on to step 62. However, if the motor direction is backwards, the routine goes from step 80 to step 84, where the hall counter is decremented by three, and then the routine proceeds to step 62.

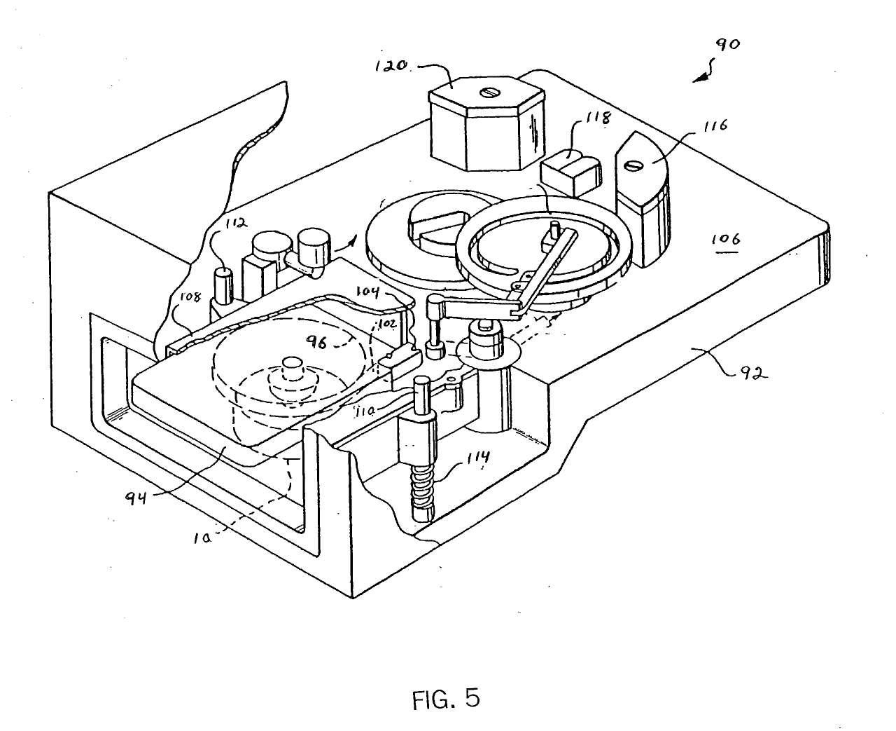

As will be understood by those of ordinary skill in the art, brushless motor system 10 may be used in many different types of applications. For example, the motor is very well suited for use in a tape drive mechanism, as illustrated in FIG. 5. This Figure, more specifically, is a perspective view of tape drive mechanism 90, including a base plate 92 on which various standard components of a magnetic tape transport may be mounted. A supply cartridge 94 is replaceable and includes a reel 96 of magnetic tape 102. A leader block 104 is disposed externally of the cartridge, and the leading edge of the magnetic tape is attached to the side of the leader block.

Drive motor 10 for the supply reel is mounted beneath base plate 92 so that the motor shaft extends normal to the surface and slightly above surface 106 of the base plate. The motor shaft is provided with a suitable clutching arrangement that permits the motor to be coupled to the hub of the supply reel by movement of the cartridge in a direction normal to the surface. As shown, this vertical movement is achieved by the cartridge loading mechanism, a portion of which is designated by reference character 108, along shafts 110 and 112 and against springs mounted on the shafts, one of which is shown at reference numeral 114. In use, magnetic tape 102 passes an air bearing guide 116, a magnetic transducer head 118, and a second air bearing guide 120.

The preferred embodiment of the invention, as described above, provides a number of important advantages. The invention is very well suited for a counter implemented in hardware, or alternatively in software. The technique makes use of an adder (signed numbers providing subtraction) instead of standard logic blocks of counters. The use of an adder provides the capability to handle the condition of very high speeds that may cause more than a single change of the sensor states between count intervals. Also, the invention detects direction of rotation, and up to three increments in count position simultaneously. Another significant advantage of the present invention is the saving of using a quadrature detector and extra tachometer. In addition, the invention can count/detect missing hall states due to noise or high velocity. Moreover, with the above teachings, all of these advantages can be achieved via a very simple method that is easy to implement in either code or logic hardware.

While it is apparent that the invention herein disclosed is well calculated to fulfill the objects previously stated, it will be appreciated that numerous modifications and embodiments may be devised by those skilled in the art, and it is intended that the appended claims cover all such modifications and embodiments as fall within the true spirit and scope of the present invention.

What is claimed is:

1. A method of detecting and counting angular rotation of a rotating rotor of a brushless DC motor, the method comprising the steps:
sensing the position of the rotor with a group of sensors, said group of sensors having six states determined by the position of the rotor, and wherein, in each of said states, the group of sensors define an associated, respective numeric value; and
at defined periods, identifying the current state of the sensors, and using the numeric value associated with said current state to determine the direction of rotation of the rotor and the angular movement of the rotor during the time of the period.

2. A method according to claim 1, wherein the group of sensors include at least three sensors; each of said numeric values includes at least three digits; and in each of said at least six states, each of said at least three sensors contributes one digit to the numeric value associated with said state.

3. A method according to claim 2, wherein each of the numeric values is a binary number; and in each of said states, each of the at least three sensors contributes either a zero or a one to the numeric value associated with said state.

4. A method according to claim 1, wherein, as the rotor rotates in a given direction, the sensors form the six states in a given order, and wherein the using step includes the steps of
at each of the defined periods,
processing the numeric value associated with the current state to obtain a first processed value, and
comparing said first processed value to the numeric value associated with one of the states that is not the current state.

5. A method according to claim 4, wherein said one of the states is adjacent to the current state in said given order.

6. A method according to claim 4, wherein the using step includes the further steps of:
at each of the defined periods,
processing the numeric value associated with the current state to obtain a second processed value, and
comparing said second processed value to the numeric value associated with a second of the states that is not the current state.

7. A method according to claim 6, wherein said second of the states is two states from the current state in said given order.

8. A system for detecting and counting angular rotation of a rotating rotor of a brushless DC motor, the system comprising:
a group of sensors to sense the position of the rotor, each of the sensors generating a respective signal determined by the position of the rotor, and wherein the group of sensors form six different states depending on the position of the rotor, each of said states being associated with a respective numeric value; and
a processor for receiving the signals from the sensors, and using said signals, at defined periods, to identify the current state of the sensors, and to use the numeric value associated with said current state to determine the direction of rotation of the rotor and the angular movement of the rotor during the time of the period.

9. A system according to claim 8, wherein the group of sensors include at least three sensors; each of said numeric values includes at least three digits; and in each of said at least six states, each of said at least three sensors contributes one digit to the numeric value associated with said state.

10. A system according to claim 9, wherein each of the numeric values is a binary number; and the processor converts the signals from the sensors to either a zero value or a one value for use in said binary numbers.

11. A system according to claim 8, wherein, as the rotor rotates in a given direction, the sensors form the six states in a given order, and wherein
at each of the defined periods,
the processor processes the numeric value associated with the current state to obtain a first processed value, and compares said first processed value to the numeric value associated with one of the states that is not the current state.

12. A system according to claim 9, wherein at each of the defined periods,
the processor processes the numeric value associated with the current state to obtain a second processed value, and compares said second processed value to the numeric value associated with a second of the states that is not the current state.

13. A program storage device readable by a machine, tangibly embodying a series of instructions for the machine to perform method steps for detecting and counting angular rotation of a rotating rotor of a brushless DC motor, the method steps comprising:
sensing the position of the rotor with a group of sensors, said group of sensors having six states determined by the position of the rotor, and wherein, in each of said states, the group of sensors define an associated, respective numeric value; and
at defined periods, identifying the current state of the sensors, and using the numeric value associated with said current state to determine the direction of rotation of the rotor and the angular movement of the rotor during the time of the period.

14. A program storage device according to claim 13, wherein the group of sensors include at least three sensors; each of said numeric values includes at least three digits; and in each of said at least six states, each of said at least three sensors contributes one digit to the numeric value associated with said state.

15. A program storage device according to claim 14, wherein each of the numeric values is a binary number; and in each of said states, each of the at least three sensors contributes either a zero or a one to the numeric value associated with said state.

16. A program storage device according to claim 13, wherein, as the rotor rotates in a given direction, the sensors form the six states in a given order, and wherein the using step includes the steps of:
at each of the defined periods,
processing the numeric value associated with the current state to obtain a first processed value, and
comparing said first processed value to the numeric value associated with one of the states that is not the current state.

17. A program storage device according to claim 16, wherein the using step includes the further steps of
at each of the defined periods,
processing the numeric value associated with the current state to obtain a second processed value, and
comparing said second processed value to the numeric value associated with a second of the states that is not the current state.

18. A tape drive mechanism, comprising:
means for receiving a reel of magnetic tape;
a motor including a rotatable rotor;
means coupling said rotor to the reel, wherein rotation of the rotor rotates said reel;
a group of sensors to sense the position of the rotor, each of the sensors generating a respective signal determined by the position of the rotor, and wherein the group of sensors form six different states depending on the position of the rotor, each of said states being associated with a respective numeric value; and
a processor for receiving the signals from the sensors, and using said signals, at defined periods, to identify the current state of the sensors, and to use the numeric value associated with said current state to determine the direction of rotation of the rotor and the angular movement of the rotor during the time of the period.

19. A tape drive mechanism according to claim 18, wherein, as the rotor rotates in a given direction, the sensors form the six states in a given order, and wherein
at each of the defined periods,
the processor processes the numeric value associated with the current state to obtain a first processed value, and compares said first processed value to the numeric value associated with one of the states that is not the current state.

20. A tape drive mechanism according to claim 19, wherein at each of the defined periods,
the processor processes the numeric value associated with the current state to obtain a second processed value, and compares said second processed value to the numeric value associated with a second of the states that is not the current state.
